(19) United States
(12) Patent Application Publication
(10) Pub. No.: US 2007/0248763 A1
(43) Pub. Date: Oct. 25, 2007

(54) METHOD FOR APPLYING A MULTIPLE LAYER DIRECTLY TO A PAPER, BOARD OR OTHER MOVING WEB OF FIBROUS MATERIAL

(76) Inventor: Benjamin Mendez-Gallon, Konigsbronn (DE)

Correspondence Address: Todd T. Taylor & Aust, P.C., P.O. Box 560, 142 S. Main Street, Avilla, IN, 46710, US

(21) Appl. No.: 11/767,026

(22) Filed: Jun. 22, 2007

Related U.S. Application Data
(63) Continuation of application No. PCT/EP05/56047, filed on Nov. 18, 2005.

(30) Foreign Application Priority Data
Dec. 23, 2004 (DE) 10 2004 062 119.5

(51) Int. Cl. B05D 1/36

(52) U.S. Cl. 427/411

(57) ABSTRACT

The invention relates to a method for applying a multiple layer directly to a paper, board or other moving web of fibrous material during the production and/or finishing thereof, the individual layers of the multiple layer being formed of a plurality of liquid to pasty application media or liquid streams (Q₁-Qₙ), in particular aqueous pigment suspensions.

The individual application media or liquid streams (Q₁-Qₙ) are discharged onto the fibrous web without respective previous drying, without excess quantities, without mixing with one another, and without contact. The application medium which has a lower specific weight (p₁ to pₙ) and/or a lower viscosity (η₁ to ηₙ) and/or a lower surface tension (δ₁ to δₙ) than the next following application medium or the next following layer is applied to an application medium or a layer having a higher specific weight (p₁ to pₙ) and/or a higher viscosity (η₁ to ηₙ) and/or a higher surface tension (δ₁ to δₙ), so that on the fibrous web the first layer or underlayer is that application medium which has the highest values and the top layer is that application medium which has the lowest values.

### CROSS REFERENCE TO RELATED APPLICATIONS

This is a continuation of PCT application No. PCT/EP2005/056047, entitled “METHOD FOR APPLYING A MULTIPLE LAYER DIRECTLY TO A PAPER, CARDBOARD OR OTHER FIBROUS MATERIAL CONTINUOUSLY MOVING WEB”, filed Nov. 18, 2005.

### BACKGROUND OF THE INVENTION

1. Field of the Invention

The invention relates to a method for applying a multiple layer directly to a paper, board or other moving web of fibrous material during the production and/or finishing thereof, the individual layers of the multiple layer being formed of a plurality of liquid to pasty application media, in particular aqueous pigment suspensions.

2. Description of the Related Art

For economic reasons, paper, board or other fibrous webs are currently produced and also finished mainly in large widths of up to 10 m and more and also at high machine speeds.

In order to achieve good printability, these webs have to be treated by way of coating processes operated offline or online. For this purpose, a modern coating method in the form of non-contact application is often employed, the medium applied being deposited on the fibrous web as a contour layer. The application medium is composed of mixtures of mineral pigments, natural or synthetic binders and chemical aids.

The smoothness or roughness of the coated substrate in this case depends on the basic roughness or smoothness of the substrate, that is to say the fibrous web.

In order to be able to save quantities of application medium, attempts are made to carry out this application in what is known as the 1:1 method. This means that only as much medium is applied as is to remain on the fibrous web to be coated. As opposed to this, the excess application method is known, in which about 8 to 10 times the quantity of application medium has to be applied, which then has to be doctored off again by various doctoring elements to the desired coat weight, for example 6-12 g/m². It follows from this that, in the case of the 1:1 application, the quantity to be applied is very low.

In any case, the intention is for a uniform application layer reaching over the entire web width or working width to be achieved.

This requirement for uniformity is all the more difficult to implement the faster the fibrous webs run in the machines and, in addition, also depends on the quality of the fibrous web and the application medium.

Known 1:1 applicators or application units are curtain and spray applicators.

An applicator of this type, producing a curtain that is closed and substantially follows the force of gravity, can be gathered from DE-A1 197 55 625. A spray applicator which operates with pressure is disclosed by DE A1-4402627.

As stated, the curtain produced with the curtain applicator and falling onto the moving surface or the fibrous web on the basis of specific forces, for example electrostatic forces which are imparted to the application medium or under the influence of the force of gravity, and also the spraying jets from the spray applicator, are in each case deposited on the fibrous web as a contour coat and, after a certain time, are immobilized there as a film.

In order to be able to achieve a high level of coverage of the fibrous web and therefore better printing qualities, the fibrous web often has to be coated repeatedly.

According to the prior art, a plurality of applicators are needed for this purpose, which are arranged one after another for each web side and for the most part operate with an excess application.

Here, reference is made to WO 98/48113-A1.

In DE-A1 10057729, which is not a prior publication, application units and methods have already been disclosed with which double coats, that is to say layers lying one above another, can be applied with a single applicator and without contact and without any excess of medium.

In this case, mixing of the two “coats” often occurs in their boundary regions, which means that the second coat can be applied only after intermediate drying, which entails additional expenditure in terms of process and apparatus. This apparatus or this method is unsuitable for those cases in which more than two layers have to be applied.

What is needed in the art is a suitable method with which a multiple layer can be applied to one side of a moving fibrous web without intermediate drying.

### SUMMARY OF THE INVENTION

The present invention provides that the individual application media are deposited onto the fibrous web without respective previous drying (that is to say, wet on wet), without excess quantities (that is to say, 1:1), and without contact. In this case, according to the invention, the application medium which has a lower specific weight and/or a lower viscosity and/or a lower surface tension than the next following application medium or the next following layer is applied to an application medium or a layer having a higher specific weight and/or higher viscosity and/or a higher surface tension. As a result, the fibrous web comes into contact with the application medium which has the highest of the aforementioned values. In other words, the first layer located on the fibrous web is that layer having the highest of the aforementioned values and the top layer is that application medium or that layer having the lowest values.

The lighter application medium (with lower specific weight), for example, remains lying on the heavier layer on account of its physical buoyancy effect.

As a result, no blending or mixing or phase separation of the individual application media takes place. A multiple layer formed in this way may be built up quite specifically as a result. Primarily, however, such a multiple layer ensures excellent coverage of the uncoated fibrous web. The fact that this can be brought about with a single and compact applicator saves enormous investment, which constitutes a further advantage of the invention.

In an alternative embodiment according to the present invention, provision can be made for the individual application media for forming the multiple layer to be discharged separately from one another and, as they are discharged, to be led together or concentrated in the direction of the fibrous web to form a sandwich-like multiple jet or multiple curtain and applied to the fibrous web in concentrated form as an already consolidated multiple layer.

The concentration can be carried out immediately following the discharge from the machine-width nozzle or only after individual jets or individual curtains have formed. Following the concentration, depending on the type of the applicator (free jet nozzle applicator or curtain applicator), a sandwich-like jet or a sandwich-like curtain is produced. In both cases, “prefabricated” layers already stabilized to a certain extent are laid on the fibrous web.

As an alternative to this, it is also possible to discharge the individual application media separately from one another as individual jets or individual curtains and to apply them separately from one another to the fibrous web, where, laid over one another in layers, they then form said multiple layer.

Whether the layers are applied individually or in concentrated form depends on how compactly the applicator has to be constructed, on the space for the installation of the applicator or on the type of application media to be used, or depends on the product type.

In both cases, it is possible to guide the individual application media or the concentrated jet or curtain over a planar guide element during its discharge in the direction of the fibrous web. This guide element can be set obliquely. As a result, stabilization of the jet or of the multiple curtain or curtains is achieved.

In specific cases, it is advantageous if individual curtains are first concentrated in the manner of a sandwich on this oblique guide surface and combined to form the multiple layer or multiple curtain, which is then guided onward to the fibrous web, where said layer or curtain can be deposited and anchored on the fibrous web as a multiple layer already formed and stabilized. A sandwich-like curtain, for example, is more stable than an individual curtain.

According to the present invention, provision is made for the multiple layer to be formed from at least two and at most ten, preferably three, layers. With this order of magnitude, particularly good coverage of the uncoated fibrous web is possible with small quantities of individual layers.

In refinement of the invention, provision can be made for the individual application media to be discharged as an individual jet or individual curtain from a machine-width wide slot nozzle in each case or a machine-width wide slot belonging to a common nozzle in each case, the distance between the individual jets or curtains being less than 1 m, in particular less than 50 cm, but preferably about 20 cm, and the time intervals for a successive discharge from the individual wide slots being set to between 4 and 100 milliseconds.

The term “machine width” is to be understood to mean at least the width of the fibrous web to be produced or to be finished.

In order that the applied multiple layer has a high smoothness, it is expedient if this multiple layer is evened or smoothed by an equalizing or smoothing element. In this case, no medium is doctored off; instead the layer is only evened or equalized, as stated.

Further refinement of the invention can consist in the concentrated multiple jet or multiple curtain achieving a flow rate Q_{T} (for total flow rate). The latter is composed of the sum of the individual liquid streams of the individual curtains. The total flow rate Q_{T} can be between 0.5 and 30 1/min/m, in particular between 3 and 20 1/min/m, preferably between 1 and 12 1/min/m.

For this multiple layer, in particular those application media which have solids contents between 5 and 70% are suitable.

The total coat weight Δₘ total to be applied can be calculated as follows:
Δₘ total=Σ(hᵢKᵢpᵢ)i=2 to max. 10 (preferably 2 to 3)
where hᵢ is the wet film thickness or the volume per unit area of the individual application medium per m², Kᵢ is the solids content of the respective application medium, and pᵢ is the specific weight of the respective application medium.

The individual application media or liquid streams stream out of the application nozzle for the purpose of forming the multiple jet or multiple curtain, in each case having a specific outward flow velocity which may be calculated as follows:
vᵢ=Qᵢ/Sᵢ,
where Qᵢ in m³/min/m indicates the flow rate of each individual application medium, and Sᵢ indicates the gap width in m of the slot gap discharging the application medium.

According to the invention, mixing of the individual application media in the concentrated multiple jet or multiple curtain and/or in the multiple layer can be avoided, the higher the difference in the viscosity and/or the surface tension and/or the specific weight between the individual application media or layers.

The inventors have found that the lower the differences in the expansion behavior of the individual discharged media or liquid streams, the more stable is the multiple curtain then produced.

According to the invention, a viscosity difference in the region of <50%, in particular <30%, preferably <10%, should be established.

The viscosity (according to Brookfield 100 rpm) of the first layer lying at the bottom should be between 500 and 100 mPas.

In further refinement of the invention, provision can be made for the expansion forces acting on the individual adjacent application media to exhibit a maximum difference of 30%, in particular of <20%, preferably 0<5%, the setting of the expansion force difference being adjusted by adding chemical additives, such as thickeners based on acrylic esters or acrylic acid or methacrylic acid or acrylamide or acrylonitrile and so on, and the percentage proportion of these chemical additives being 0.01 to 3 T, in particular 0.01 to 0.5 T, preferably 0.01 to 0.2 T, and T being the proportion per 100 parts of the quantity of dry pigment in the chosen coating color.

Furthermore, it is very advantageous if the multiple layer is formed in such a way that the fineness of the mineral pigments, such as calcium carbonate or kaolin or TiO₂ or talc, increases toward the top. This means that each layer with the finer mineral pigments contained, that is to say the lowest diameter of the pigment particles, should be present in the respective layer lying above, the top layer of the multiple layer then finally containing the finest pigment and the highest whiteness of the pigments.

The following mixture ratios are proposed:
100 T (T=parts) CaCO₃(*)
100 T kaolin (*)
CaCO₃ and kaolin mixtures with 5 to 50 T kaolin (*)
CaCO₃+kaolin and TiO₂ or talc in a different ratio, the proportion of CaCO₃ and kaolin predominating
((*): based on the dry weight of the pigment contained or of the pigments contained, that is to say only carbonate or only kaolin).

In this case, quantities of binder of the order of magnitude of 4 to 20 parts can be contained, based on the dry weight of the pigments contained.

Suitable binders are natural binders such as starch (maize, potato, tapioca, wheat, barley, etc.), casein, etc., and synthetic binders such as latices (based on styrene butadiene or based on acrylate, etc.).

The aids provided can be:
thickeners for adjusting the viscosity and the elasticity (0.01 to 10 T)
emulsifiers or surfactants for adjusting the curtain stability (0.01 to 3 T)
defoamers for avoiding the formation of foam (0.01 to 1 T)
optical whitening agents with associated “carriers” 0.01 to 23 T
wet strength agents (crosslinkers) 0.01 to 3 T
specific media (lubricants, etc.) 0.01 to 1 T
tinting substances for coloring the coating colors 0.1 to 5 T
boundary surface active substances for intensifying the separation between the boundary surfaces of the individual films in the multilayer curtain 0.01 to 1 T, where T means the percentage proportion of the agent per 100 parts of the quantity of dry pigment in the application medium.

The application of the multiple layer can most advantageously be performed with a curtain applicator, with which a plurality of different liquid to pasty application media are discharged onto the moving fibrous web in the form of a plurality of curtains or in the form of one concentrated and closed curtain substantially following the force of gravity and/or directed under the influence of electrostatic forces.

Alternatively, it is also possible for the application of the multiple layer to be performed with a spray or free jet nozzle applicator, with which a plurality of different liquid to pasty application media are discharged onto the moving fibrous web in the form of a plurality of jets or in the form of a single concentrated jet directed onto the fibrous web under pressure.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows, in a schematic illustration, the principle of the invention using the example of a fibrous web coated with a multiple layer by way of a curtain applicator;

FIGS. 2 to 5 show, in a schematic illustration, curtain applicators according to the invention with which a multiple layer according to the invention is applied; and

FIG. 6 shows, in a schematic illustration, the principle of the invention with the illustration of velocity profiles in a multiple curtain.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

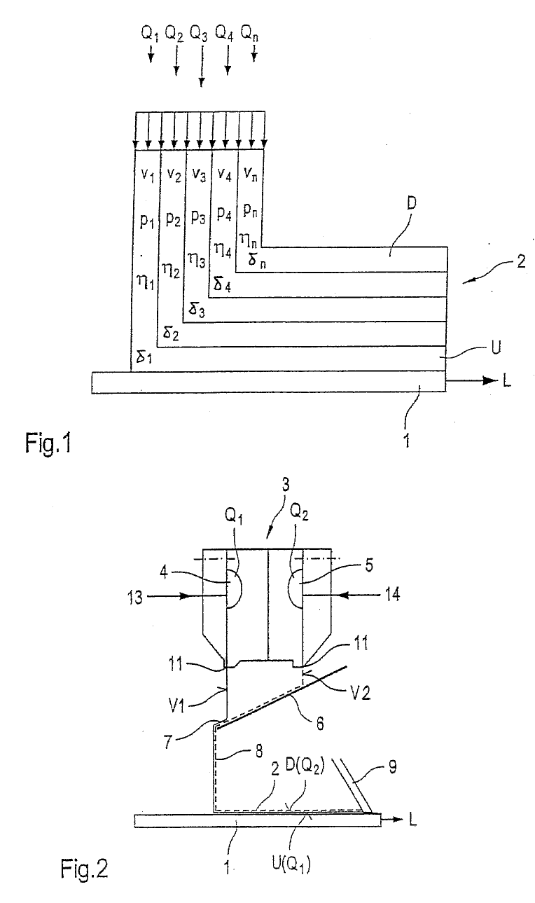

Referring now to the drawings, and more particularly to FIG. 1, there is shown a fibrous web 1, onto which a multiple layer 2, composed of a plurality of different liquid streams Q₁, Q₂, Q₃, Q₄, Qn (in the example, five different media are illustrated) are applied in a direct way. The thickness of the multiple layer 2 is relatively constant and relatively independent of the topography of the fibrous web surface. It can be seen that the individual liquid streams in the chosen example are discharged in the form of an equal number of individual curtains V1 to Vn falling vertically onto the fibrous web 1. The curtain applicator used for this purpose and acting without contact is not also illustrated here.

The individual liquid streams Q₁ to Qₙ include a plurality of coating colors which, in terms of their composition and rheology, can be different and are each composed of a mixture of mineral pigments, natural or synthetic binders and chemical aids.

The individual liquid streams Q₁ to Qₙ are discharged onto the fibrous web 1 without previous drying—that is to say wet on wet—and without excess quantities—that is to say 1:1—and without contact. In this case, according to the invention, the application medium which has a lower specific weight p and/or a lower viscosity η and/or a lower surface tension δᵢ than the next following application medium or the next liquid stream or the next following layer is applied to an application medium or a layer having a higher specific weight and/or a higher viscosity and/or a higher surface tension. As a result, the fibrous web 1 comes into contact with that application medium which has the highest values (which is then Q₁ with a specific weight p₁, viscosity ηₙ and the surface tension δ₁).

In other words, the first layer or underlayer U located on the fibrous web is that layer having the highest values, and the top layer D is that application medium Qₙ or that layer having the lowest values of p, η or δ.

This can be illustrated as follows:
p₁>p₂>p₃>p₄>pₙ . . . Pᵢ
η₁>η₂>η₃>η₄>ηₙ . . . ηᵢ
δ₀>δ₁>δ₂>δ₃>δ₄>δₙ . . . δᵢ
   (where δ₀ is the surface tension of uncoated paper, δ₁₋ₙ that of the individual colored layers)

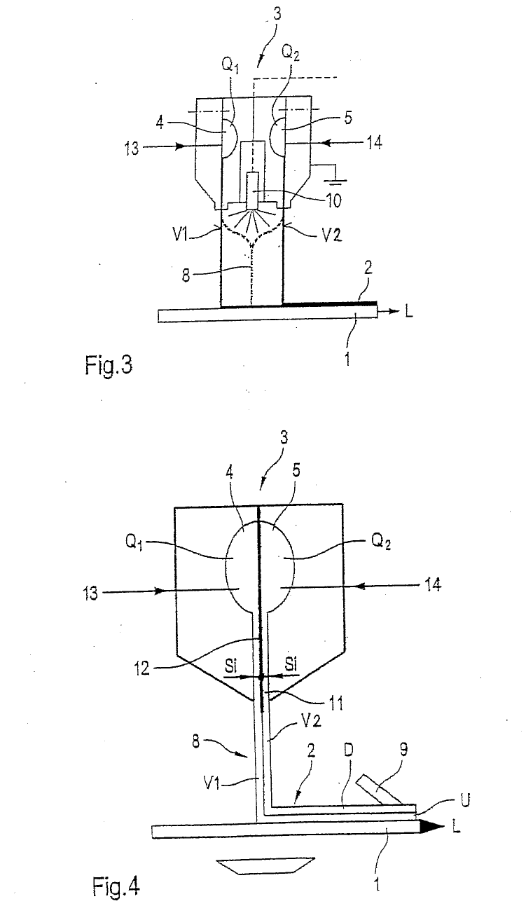

FIG. 2 shows the application of the invention using the example of a double curtain applicator 3, illustrated in cross section and schematically, for the application of the multiple layer 2, as described in principle in FIG. 1.

It is possible to see two feed chambers 4 and 5 for two different application media or liquid streams Q₁ and Q₂, which are applied in the form of two physically separated curtains V1 and V2 to a guide surface 6 set obliquely. The guide surface 6 is inclined in the direction of the first curtain V1. On this guide surface 6, the two curtains V1 and V2 are combined or concentrated to form a double layer 7 and, in this concentrated form, that is to say as a multiple curtain 8 (a double curtain here), are placed on each other and in this way discharged onto the fibrous web 1 moving underneath in the running direction L. In this case, the layer resulting from the second curtain V2 or a liquid stream Qₙ comes to lie on the fibrous web as the top layer D. The top layer D has the finer particles and the lower values than the underlayer U of the layer or the liquid stream Q₁ or the further layers likewise lying underneath in the case of a plurality of curtains. The length of the concentrated curtain falling vertically is approximately 50 to 300 mm.

Finally in FIG. 2, a blade-like equalizing element 9 is also illustrated, which is intended to equalize and therefore smooth the applied multiple layer 2, the double layer here.

FIG. 3 shows a different principle of the application of a multiple layer 2. As distinct from the solution shown in FIG. 2, there is no guide surface 6 here. The concentration of the curtains V1 and V2 to form a multiple or double curtain 8 is carried out here under the action of electrostatic forces. An appropriate electrode 10 pulls the curtains V1 and V2 shown here together toward the center, so that here, too, the curtain V2 again forms the upper layer, that is to say the top layer D of the multiple coat 2 according to FIG. 1.

In the variant shown in FIG. 4, the application medium Q₁ and Q₂ resulting from distribution chambers 4 and 5 is concentrated immediately after emerging from the slot nozzle II of the applicator 3, without a guide surface or other forces being involved. There is merely a dividing wall 12, for example of polytetrafluoroethylene, in the interior of the applicator 3 in order to separate the two different application media Q₁ and Q₂. It can be seen that the existing curtain V2 again occurs as the top layer D according to the explanation in the case of FIG. 1.

FIG. 5 is intended to show that the multiple layer can also be discharged onto the fibrous web 1 from two individually discharged curtains V1 and V2 without previous concentration. In the multiple layer 2, V2 is again deposited as the top layer D. Equalizing elements 9 are likewise illustrated again in FIGS. 4 and 5.

It should also be added that the applicators 3 shown in FIGS. 2 and 3 contain a plurality of wide slot nozzles II which are arranged in parallel and which are in each case charged by separate feed systems 13 and 14.

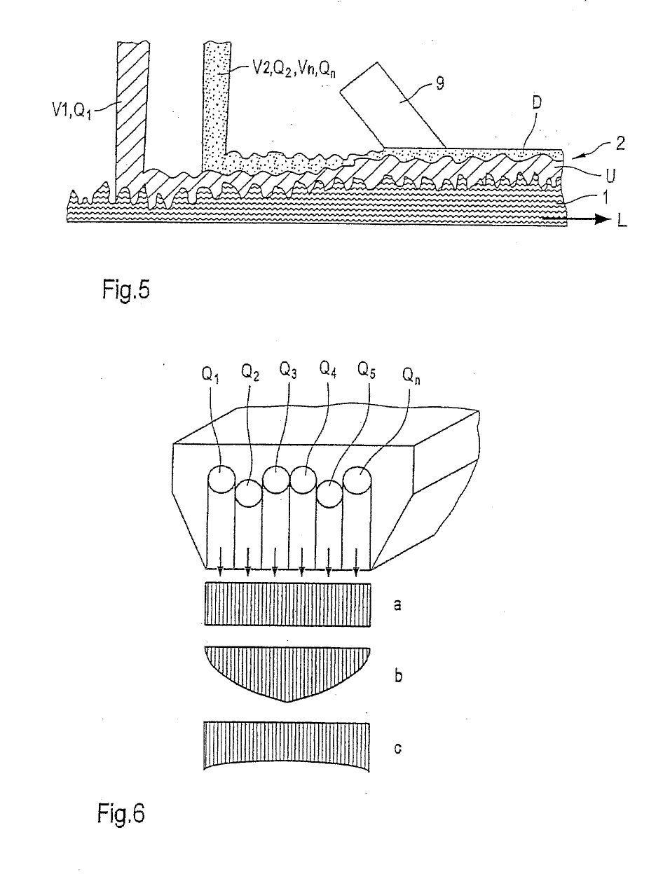

In order to guarantee high stability and optimum conditions during the formation of the multiple curtain 8, the following conditions, inter alia, must be maintained. That is, the outward flow velocity of the individual application media from the nozzle or at the point where they are concentrated is chosen in such a way that, in the cross section of the curtain 8, a velocity profile exhibits similarity to the velocity profiles illustrated in FIG. 6. Three cases are shown in FIG. 6—Case (a), Case (b) and Case (c).

According to Case (a), the outward flow velocity of all the application media or liquid streams Q₁ to Qₙ is equal, so that a velocity profile without any relative velocity between the phase boundaries of the individual liquid application media is established. No shearing or extension processes take place at the phase boundaries in the multiple curtain.

According to Case (b), the flow velocity decreases continuously outward from the center of the multilayer curtain. The inner application media have a higher outward flow velocity than the outer application media. The velocity difference between adjacent application media must optimally be no greater than 20% (preferably<10% and particularly preferably<5%). A convex course of the velocity profile is established.

According to Case (c), the flow velocity increases continuously outward from the center of the multilayer curtain. The inner media have a lower velocity than the outer media. The velocity difference between adjacent media must optimally be no greater than 20%. A concave course of the velocity profile is established.

Velocity profiles with a course similar to a zigzag are unsuitable for the formation of multilayer curtains, since relative velocities initiate extension and mixing processes which deform, buckle or disrupt the multiple or multilayer curtain.

In all the figures shown, it is the case that the finer and whiter pigments, such as those of calcium carbonate or kaolin or TiO₂ or talc, form this top layer D of the multiple layer 2. Thus, the method according to the invention permits a high-quality application layer. The invention is therefore particularly suitable for paper and board webs which are intended to exhibit high printing qualities.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### List of Designations

1 Fibrous web
2 Multiple layer
3 Double curtain applicator
4 Feed chamber
5 Feed chamber
6 Guide surface
7 Double layer
8 Multiple curtain
9 Equalizing element
10 Electrode
11 Slot nozzle
12 Dividing wall
13 Feed system
14 Feed system
D Top layer
L Running direction
p, pᵢ Specific weight
Q₁, Q₂, Q₃, . . . Qₙ Liquid stream
Q_{T} Total flow rate
Si Gap width of the slot nozzle
U Underlayer
V1, V2, V3, . . . Vn Individual curtain
vᵢ Outward flow velocity of the individual application medium or liquid stream
Δₘ Total coat weight
hᵢ Wet film thickness or volume per unit area of the individual application medium or liquid stream
Kᵢ Solids content of the individual application medium or liquid stream
pᵢ Specific weight of the individual application medium or liquid stream
η, ηᵢ Viscosity
δ, δᵢ, δ₀ Surface tension

What is claimed is:

1. A method for applying a multiple layer directly to a moving fibrous web during at least one of a production and a finishing thereof, the multiple layer including a plurality of individual layers, and the plurality of individual layers being one of a plurality of liquid to pasty application media and a plurality of liquid streams, the method comprising the steps of:
discharging separately from one another individual ones of one of said plurality of liquid to pasty application media and said plurality of liquid streams onto the fibrous web without respective previous drying, without excess quantities, without mixing with one another, and without contact;
applying an application medium which has at least one of a lower specific weight, a lower viscosity, and a lower surface tension than one of a next following application medium and a next following layer to one of an application medium and a layer having at least one of a higher specific weight, a higher viscosity, and a higher surface tension so that on the fibrous web one of a first layer and an underlayer is that application medium which has the highest values and a top layer is that application medium which has the lowest values;
as individual ones of one of said plurality of application media and said plurality of liquid streams are discharged, one of leading together and concentrating individual ones of one of said plurality of application media and said plurality of liquid streams in a direction of the fibrous web to form one of a sandwich-like multiple jet and a sandwich-like multiple curtain; and
applying individual ones of one of said plurality of application media and said plurality of liquid streams to the fibrous web in concentrated form as an already consolidated multiple layer.

2. The method of claim 1, wherein individual ones of one of said plurality of application media and said plurality of liquid streams include a plurality of aqueous pigment suspensions.

3. The method of claim 1, wherein individual ones of one of said plurality of application media and said plurality of liquid streams are discharged separately from one another as one of a plurality of individual jets and a plurality of individual curtains and are applied separately from one another to and laid over one another on the fibrous web where individual ones of one of said plurality of application media and said plurality of liquid streams then form the multiple layer.

4. The method of claim 1, wherein individual ones of one of said plurality of application media and said plurality of liquid streams are discharged separately from one another as one of a plurality of individual jets and a plurality of individual curtains and are each guided over a planar guide surface as individual ones of one of said plurality of application media and said plurality of liquid streams are discharged in the direction of the fibrous web.

5. The method of claim 4, wherein said planar guide surface is that on which individual ones of one of said plurality of application media and said plurality of liquid streams are one of led together and concentrated to form the multiple layer, after which individual ones of one of said plurality of application media and said plurality of liquid streams are guided onward as one of a sandwich-like multiple jet and a sandwich-like multiple curtain to the fibrous web, where one of the multiple layer and said multiple curtain is deposited and anchored on the fibrous web as a multiple layer already formed.

6. The method of claim 1, wherein the multiple layer is formed from at least two layers.

7. The method of claim 1, wherein the multiple layer is formed from at most ten layers.

8. The method of claim 1, wherein the multiple layer is formed from three layers.

9. The method of claim 1, wherein individual ones of one of said plurality of application media and said plurality of liquid streams are discharged as one of an individual jet and individual curtain from one of a machine-width wide slot nozzle in each case and a machine-width wide slot belonging to a common nozzle in each case, the distance between one of said individual jets and said individual curtains being less than 1 m, and the time intervals for a successive discharge from said individual slot nozzles being set to ≦2 s.

10. The method of claim 1, wherein individual ones of one of said plurality of application media and said plurality of liquid streams are discharged as one of an individual jet and individual curtain from one of a machine-width wide slot nozzle in each case and a machine-width wide slot belonging to a common nozzle in each case, the distance between one of said individual jets and said individual curtains being less than 50 cm, and the time intervals for a successive discharge from said individual slot nozzles being set to 0≦1 s.

11. The method of claim 1, wherein individual ones of one of said plurality of application media and said plurality of liquid streams are discharged as one of an individual jet and individual curtain from one of a machine-width wide slot nozzle in each case and a machine-width wide slot belonging to a common nozzle in each case, the distance between one of said individual jets and said individual curtains being about 20 cm, and the time intervals for a successive discharge from said individual slot nozzles being set to ≦0.5 s.

12. The method of claim 1, wherein the multiple layer applied to the fibrous web is one of evened and smoothed with one of an equalizing and a smoothing element.

13. The method of claim 1, wherein one of said concentrated multiple jet and said concentrated multiple curtain achieves a total flow rate which includes one of a plurality of flow rates and said plurality of liquid streams of individual layers of said multiple curtain, said total flow rate being between 0.5 and 30 1/min/m.

14. The method of claim 1, wherein one of said concentrated multiple jet and said concentrated multiple curtain achieves a total flow rate which includes one of a plurality of flow rates and said plurality of liquid streams of individual layers of said multiple curtain, said total flow rate being between 3 and 20 1/min/m.

15. The method of claim 1, wherein one of said concentrated multiple jet and said concentrated multiple curtain achieves a total flow rate which includes one of a plurality of flow rates and said plurality of liquid streams of individual layers of said multiple curtain, said total flow rate being between 1 and 12 1/min/m.

16. The method of claim 15, wherein one of said plurality of liquid to pasty application media and said plurality of liquid streams which has solids contents between 5% and 70% forms the multiple layer.

17. The method of claim 1, wherein individual ones of one of said plurality of application media and said plurality of liquid streams for forming the multiple layer have in each case an outward flow velocity which is calculated as follows:
vᵢ=Qᵢ/Sᵢ,
where Qᵢ (in m³/min/m) indicates the flow rate of each individual ones of one of said plurality of application media and said plurality of liquid streams, and Sᵢ (in m) indicates a gap width of a slot nozzle from which respective said individual application medium is discharged.

18. The method of claim 1, wherein mixing of individual ones of one of said plurality of application media and said plurality of liquid streams in at least one of one of said concentrated multiple jet and said concentrated multiple curtain and the multiple layer is avoided, the higher the difference in at least one of a viscosity, a surface tension, one of a plurality of viscoelastic properties, an extensibility, and an expansion force, and a specific weight between individual ones of one of said plurality of application media, said plurality of liquid streams, and said plurality of layers.

19. The method of claim 18, wherein said expansion force of adjacent individual ones of one of said plurality of application media and said plurality of liquid streams is at most 30%, a setting of said expansion force being adjusted by adding a plurality of chemical additives, and a percentage proportion of said plurality of chemical additives being 0.01 to 3 T, T being a proportion per 100 parts of a quantity of a dry pigment in respective one of said application medium and liquid stream.

20. The method of claim 19, wherein said expansion force of adjacent individual ones of one of said plurality of application media and said plurality of liquid streams is <20%.

21. The method of claim 19, wherein said expansion force of adjacent individual ones of one of said plurality of application media and said plurality of liquid streams is 0<5%.

22. The method of claim 19, wherein said plurality of chemical additives includes a plurality of thickeners based on one of acrylic esters, acrylic acid, methacrylic acid, acrylamide, and acrylonitrile.

23. The method of claim 19, wherein said percentage proportion of said plurality of chemical additives is 0.01 to 0.5 T.

24. The method of claim 19, wherein said percentage proportion of said plurality of chemical additives is 0.01 to 0.2 T.

25. The method of claim 19, wherein T is a proportion per 100 parts of said quantity of said dry pigment in a coating color.

26. The method of claim 1, wherein the multiple layer is formed in such a way that each layer with a finer plurality of mineral pigments contained, that is to say a lowest diameter of a plurality of pigment particles, is present in a respective layer lying above, said top layer of the multiple layer then finally having a finest pigment and a highest whiteness of said plurality of mineral pigments.

27. The method of claim 26, wherein said plurality of mineral pigments includes one of calcium carbonate, kaolin, TiO₂, and talc.

28. The method of claim 1, wherein the multiple layer is applied with a curtain applicator, with which different ones of one of said plurality of liquid to pasty application media and said plurality of liquid streams are discharged onto the moving fibrous web as one of a plurality of curtains and one concentrated and closed curtain at least one of substantially following the force of gravity and substantially directed under an influence of a plurality of electrostatic forces.

29. The method of claim 1, wherein the multiple layer is applied with one of a spray and a free jet nozzle applicator, with which different ones of said plurality of liquid to pasty application media are discharged onto the moving fibrous web in a form of one of a plurality of jets and a single concentrated jet directed onto the fibrous web under pressure.
